(19) United States
(12) Patent Application Publication
(10) Pub. No.: US 2025/0304300 A1
(43) Pub. Date: Oct. 2, 2025

(54) STACKING AND WRAPPING SYSTEM AND A METHOD OF USING SAME

(71) Applicant: Lyric Automation Canada Corporation, Markham (CA)

(72) Inventors: GORAN MARKOVIC, NEWMARKET (CA); MILOS BALJOZOVIC, TORONTO (CA); PAULUS KONG, NORTH YORK (CA); MATTHEW YU SONG XIE, MARKHAM (CA); PETER GUAN, NEWMARKET (CA); JIAYE LI, RICHMOND (CA)

(21) Appl. No.: 19/094,374

(22) Filed: Mar. 28, 2025

Related U.S. Application Data
(60) Provisional application No. 63/571,069, filed on Mar. 28, 2024.

(51) Int. Cl. B65B 11/02; B65B 25/00; B65B 35/50

(52) U.S. Cl. CPC B65B 11/025; B65B 25/00; B65B 35/50

(57) ABSTRACT

A stacking and packing system is for stacking and packing a plurality of products with a wrap. The stacking and packing system includes a Z stacking subsystem, a pick and place subsystem and a wrap management subsystem. The Z stacking subsystem has a stacking zone and is configured to stack the plurality of products and position the wrap between each of the plurality of products to form a plurality of stacked and wrapped product. The pick and place subsystem is configured to place one of the plurality of products onto the stacking zone. The wrap management subsystem is configured to move the wrap to the stacking zone. Preferably, the first and second wrapping pins are spaced from the products. In one example the product is alternating anodes and cathodes and the plurality of stacked and wrapped product is a battery.

### BACKGROUND

The present disclosure relates to systems for wrapping and stacking products. The system is particularly suited for stacking and wrapping fragile products such as thin cells.

It is well known in the art that packaging fragile products can be very challenging. Some products may be damaged by exerting any pressure on the product.

Accordingly, it would be advantageous to provide a stacking and wrapping system that may be used with fragile products.

### SUMMARY

A further understanding of the functional and advantageous aspects of the disclosure can be realized by reference to the following detailed description and drawings.

A stacking and packing system is for stacking and packing a plurality of products with a wrap. The stacking and packing system includes a Z stacking subsystem, a pick and place subsystem and a wrap management subsystem. The Z stacking subsystem has a stacking zone and is configured to stack the plurality of products and position the wrap between each of the plurality of products to form a plurality of stacked and wrapped product. The pick and place subsystem is configured to place one of the plurality of products onto the stacking zone. The wrap management subsystem is configured to move the wrap to the stacking zone.

The Z-stacking subsystem may include a first wrapping pin assembly having a first wrapping pin and a second wrapping pin assembly having a second wrapping pin wherein the second wrapping pin is spaced from the first wrapping pin. The first wrapping pin and the second wrapping pin may be configured to be positioned on opposing sides of one of the plurality of products when positioned in the stacking zone.

The first wrapping pin and the second wrapping pin may be spaced from one of the plurality of products when positioned in the stacking zone.

The first wrapping pin and the second wrapping pin may be configured to move from an engaged position to a rest position wherein in the engaged position the first wrapping pin and the second wrapping pin may be on opposing sides of the stacking zone and in the rest position may be spaced from the stacking zone.

The first wrapping pin and the second wrapping pin may slide outwardly from the engaged position to the rest position generally horizontally.

The Z-stacking subsystem further includes a first foot assembly may have a first foot and a second foot assembly having a second foot wherein the second foot is spaced from the first foot.

The first foot and the second foot may each be configured to move from an engaged position to a rest position.

The engaged position for each of the first foot and the second foot may be in registration with the first wrapping pin and the second wrapping pin respectively.

The pick and place subsystem may include a suction head for picking up one of the plurality of products.

The wrap management subsystem may be configured to move the wrap backwardly and forwardly over the loading zone.

The wrap management subsystem may be further configured to tension the wrap as it moves backwardly and forwardly over the loading zone.

The stacking and packing system may further include a movement system for of the plurality of stack and wrapped product.

The plurality of products may be a plurality of thin cells.

The wrap may be a single continuous wrap.

The plurality of products may include alternating anodes and cathodes and the wrap is a packing material wherein the wrapped and stacked product forms a battery cell.

A Z stacking system for use with a product and a wrap includes a stacking zone for receiving the wrap and a product thereon; a first wrapping pin assembly having a first wrapping pin and a second wrapping pin assembly having a second wrapping pin wherein the second wrapping pin is spaced from the first wrapping pin on opposing sides of the stacking zone; and a first foot assembly having a first foot and a second foot assembly having a second foot wherein the second foot is spaced from the first foot on opposing side of the stacking zone.

The first wrapping pin and the second wrapping pin may be configured to be spaced from the product

A method of stacking and packing a plurality of products having wrap therebetween using a first pin, a corresponding first foot, a second pin, and a corresponding second foot, the method comprises the steps of:
a) laying down the wrap;
b) moving the first pin and the second pin into an engagement position;
c) placing a product on the wrap between the first pin and the second pin with a loader;
d) wrapping the product with the wrap up to the loader and around the first pin;
e) moving the first corresponding foot into the engagement position over the first pin and pressing down;
f) moving the second pin into a rest position;
g) moving the loader;
h) wrapping the remainder of the product;
i) moving the second pin into the engagement position on top of the wrap;
j) placing another product on the wrap between the first pin and the second pin with the loader;
k) wrapping the product with the wrap up to the loader and around the second pin;
l) moving the second corresponding foot into the engagement position over the second pin and pressing down;
m) moving the first pin into the rest position;
n) moving the loader;
o) repeating steps c) to l) until all of the plurality of products has been placed on the wrap; and
p) cutting the wrap.

The sequence of step f) and sequence of step m) may be variable.

The product in step c) may be a first product and the product in step j) may be a second product. The first product may be an anode and the second product may be a cathode. The wrapped and stacked plurality of products may be a battery.

The wrap may be tensioned.

The first wrapping pin and the wrapping second pin may be moved from the engaged position to the rest position generally horizontally.

The method of stacking and packing may further include the step of moving the wrapped and stacked plurality of products to a predetermined location.

The first wrapping pin and corresponding first foot may be in registration in the engagement position.

### BRIEF DESCRIPTION OF THE DRAWINGS

Embodiments will now be described, by way of example only, with reference to the drawings, in which:

FIG. 1A is a perspective view of a stacking and packaging system;

FIG. 1B is a perspective view of the stacking and packaging system of FIG. 1A but having a portion of the pick and place sub-system not shown;

FIG. 2 is a perspective view of the Z-stacking subsystem of the stacking and packaging system shown in FIG. 1A;

FIG. 3A is an enlarged perspective view of a foot assembly of the Z-stacking subsystem shown in FIG. 2;

FIG. 3B is an enlarged perspective view of a foot of the foot assembly shown in FIG. 3A;

FIG. 4 is an enlarged perspective view of a wrapping pin of the Z-stacking subsystem shown in FIG. 2;

FIG. 5 is an enlarged perspective view of an intermediate platform of the stacking and packaging system shown in FIG. 1A;

FIG. 6 is an enlarged perspective view of a wrap management subsystem of the stacking and packaging system shown in FIG. 1A;

FIG. 7 is an enlarged perspective view of a pick and place subsystem of the stacking and packaging system shown in FIG. 1A;

FIG. 8 is a flow chart of the steps of the stacking and packaging system;

FIG. 9A is an enlarged perspective view of a portion of the Z-stacking subsystem shown in FIG. 2 and showing the step of placing the product onto a wrap;

FIG. 9B is an enlarged perspective view of a portion of the Z-stacking subsystem similar to that shown in FIG. 9A but showing the step of wrapping product with wrap onto the loader;

FIG. 9C is an enlarged perspective view of a portion of the Z-stacking subsystem similar to that shown in FIGS. 9A and 9B but showing the step of engaging a foot on the wrap and pressing down;

FIG. 9D is an enlarged perspective view of a portion of the Z-stacking subsystem similar to that shown in FIGS. 9A, 9B and 9C but showing the step of disengaging a wrap pin further away from a tension end of the wrap;

FIG. 9E is an enlarged perspective view of a portion of the Z-stacking subsystem similar to that shown in FIGS. 9A, 9B, 9C and 9D but showing the step of removing the loader from the product;

FIG. 9F is an enlarged perspective view of a portion of the Z-stacking subsystem similar to that shown in FIGS. 9A, 9B, 9C, 9D and 9E but showing the step of wrapping the rest of the product with the wrap; and

FIG. 9G is an enlarged perspective view of a portion of the Z-stacking subsystem similar to that shown in FIGS. 9A, 9B, 9C, 9D, 9E and 9F but showing the step of engaging a wrapping pin and pressing down on the wrap.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, the terms “comprises” and “comprising” are to be construed as being inclusive and open ended, and not exclusive. Specifically, when used in the specification and claims, the terms “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately” are meant to cover variations that may exist in the upper and lower limits of the ranges of values, such as variations in properties, parameters, and dimensions. Unless otherwise specified, the terms “about” and “approximately” mean plus or minus 25 percent or less.

It is to be understood that unless otherwise specified, any specified range or group is as a shorthand way of referring to each and every member of a range or group individually, as well as each and every possible sub-range or sub-group encompassed therein and similarly with respect to any sub-ranges or sub-groups therein. Unless otherwise specified, the present disclosure relates to and explicitly incorporates each and every specific member and combination of sub-ranges or sub-groups.

As used herein, the term “on the order of”, when used in conjunction with a quantity or parameter, refers to a range spanning approximately one tenth to ten times the stated quantity or parameter.

As used herein the “operably connected” or “operably attached” means that the two elements are connected or attached either directly or indirectly. Accordingly the items need not be directly connected or attached but may have other items connected or attached therebetween.

It is to be noted that the specification and claims of the application and the terms “first”, “second” and the like in the drawings are used to distinguish similar objects, and do not need to describe a specific sequence or a precedence order. It will be appreciated that data used in such a way may be exchanged under appropriate conditions, in order that the embodiments of the application described here can be implemented in a sequence other than sequences graphically shown or described here. In addition, terms “include” and “have” and any variations thereof are intended to cover non-exclusive inclusions. For example, it is not limited for processes, methods, systems, products or devices containing a series of steps or modules or units to clearly list those steps or modules or units, and other steps or modules or units which are not clearly listed or are inherent to these processes, methods, products or devices may be included instead.

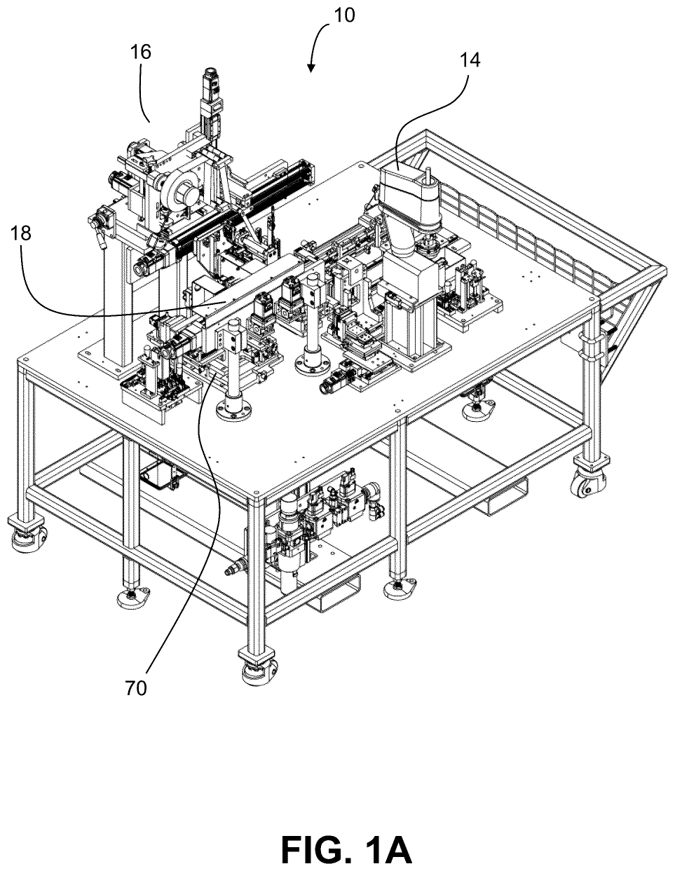

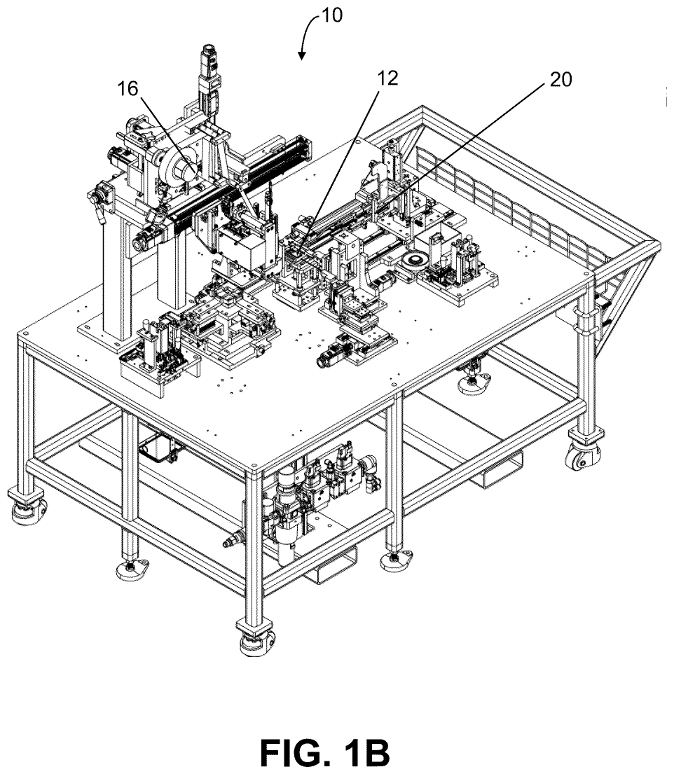

Referring to the FIGS. 1A and 1B a stacking and packing system is shown generally at 10. The stacking and packing system is for stacking and packing a plurality of products with a wrap. The stacking and packing system 10 includes a Z stacking subsystem 12, a pick and place subsystem 14 and a wrap management subsystem 16. The stacking and packing system 10 further includes a product delivery system 18 for delivery the product to the pick and place subsystem 14. It also includes a movement system 20 for the stacked and wrapped product.

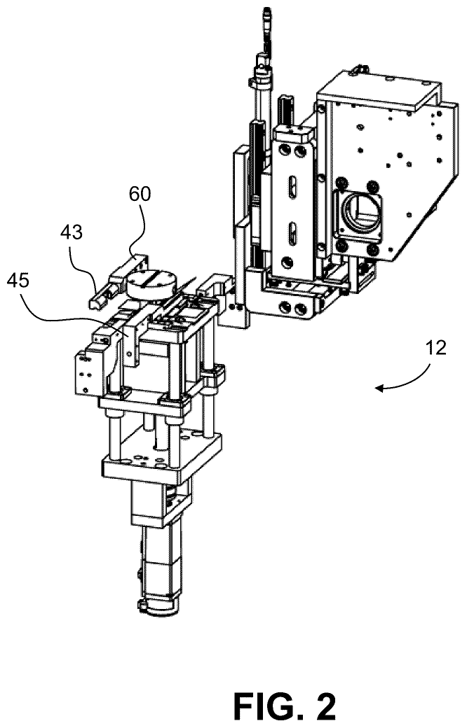

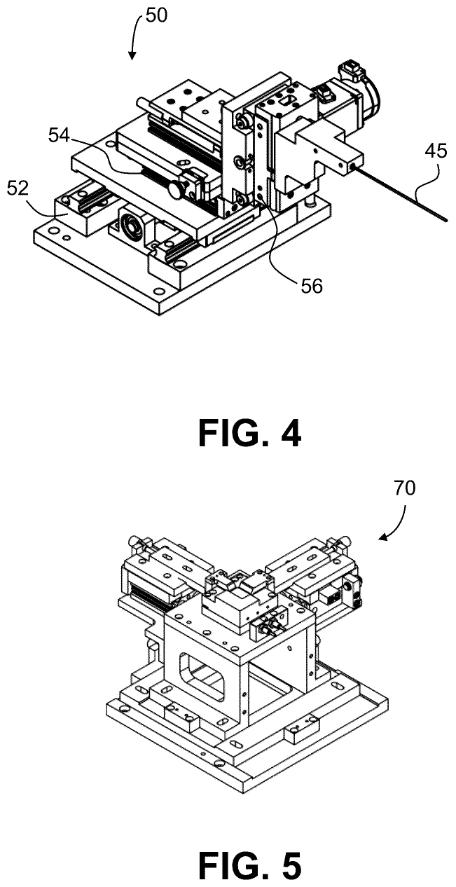

Referring to FIGS. 2, 3A, 3B and 4, the Z stacking subsystem 12 has a stacking zone defined by the first wrapping pin 45 and a second wrapping pin 46. In the embodiment shown herein the dimensions of the stacking zone are determined by the dimensions of the intended product. The first wrapping pin 45 and the second wrapping pin 46 are spaced apart and configured to be positioned on opposing sides of the product 47. The wrapping pins 45 and 46 are configured to not touch the product or stated another way are configured to be spaced from the products. The wrapping pins 45 and 46 are stiff enough for the wrap 48 to wrap around them. The wrapping pins 45 and 46 are moveable from an engaged position when they are on opposed sides of the stacking zone and holding a wrap 48 in position. Each wrapping pin 45 is held in position with a wrapping pin assembly 50 as best seen in FIG. 4.

The wrapping pin assembly 50 is a modular assembly that is configured to move the wrapping pin 45 forwardly and backwardly along rails 52, inwardly and outwardly along rails 54 and upwardly and downwardly along rails 56. Servo motors are used to drive the wrapping pin assembly 50 in the different directions.

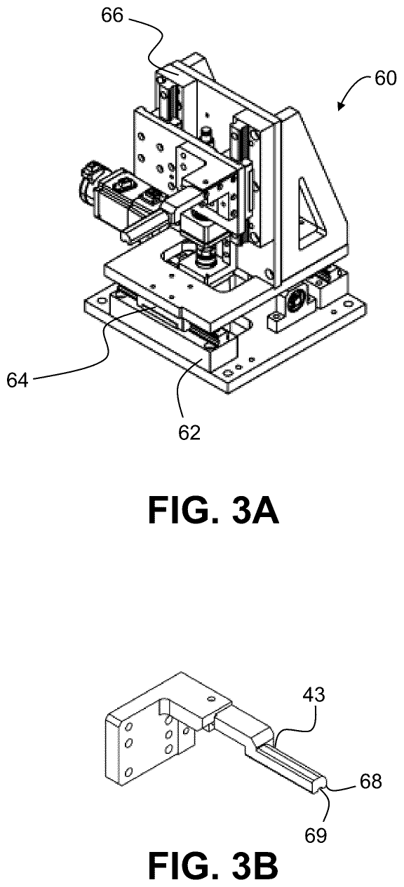

The stacking and packing system 10 also includes a first foot 43 and a second foot 44. The first foot 43 and the second foot 44 are configured to be positioned in registration with the first wrapping pin 45 and second wrapping pin 46 respectively. The first foot 43 and the second foot 44 are moveable from an engaged position to a rest position. The first foot 43 is in an engaged position when the foot is positioned over the wrapping pin 45 and is pushed on the wrap 48. Each foot 43 is held in place with a foot assembly 60 best seen in FIGS. 3A and 3B.

The foot assembly 60 is a modular assembly that is configured to move first foot 43 forwardly and backwardly along rails 62, inwardly and outwardly along rails 64 and upwardly and downwardly along rails 66. Servo motors are used to drive the wrapping pin assembly 60 in the different directions. The first foot 43 is generally elongate with a flat bottom 68 which has a groove 69 formed therein. The groove 69 is formed therein so that the first foot 43 can fit over the first wrapping pin 45.

The stacking and packing system 10 includes an intermediate platform 70 as shown in FIG. 5.

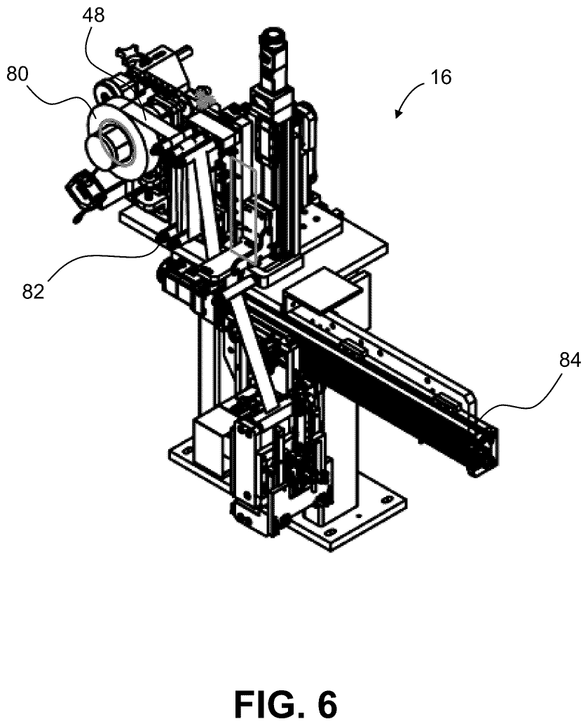

The wrap management subsystem 16 is shown in FIG. 6. A spool 80 of the wrap 48 is rotatably attached to the wrap management subsystem 16. Preferably the wrap 48 is a single continuous wrap. The wrap 48 is fed through a series of pullies 82 to aid in the tensioning of the wrap. The wrap management subsystem 16 includes a linear actuator 82 configured to move the wrap backwardly and forwardly over the stacking zone.

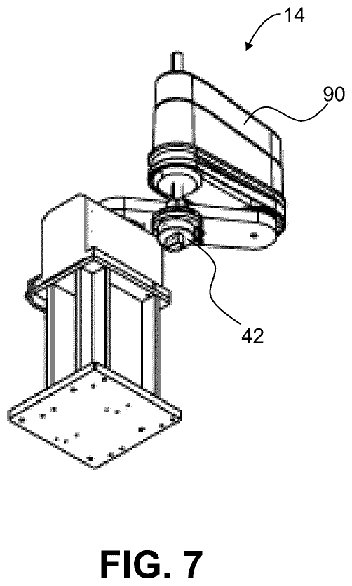

The pick and place subsystem 14 is shown generally in FIG. 7. The pick and place subsystem 14 includes a robotic arm 90. A suction head 42 is attached to robotic arm 90. The suction head 42 is for loading the product 47 onto the stacking zone.

The stacking and packing system may further include a movement system for of the plurality of stack and wrapped product.

In the embodiment shown herein the product is a thin cell. More specifically the products are fragile anodes and cathodes and the wrap is a specific packing material called a separator. In the embodiment shown herein the product being positioned on the wrap alternates between an anode and a cathode. Collectively the anodes, cathodes and separator form a battery cell.

However, it will be appreciated by those skilled in the art that this stacking and packing system may be adapted to be used with a variety of different products and in different industries. For example, the products being packaged together need not all be the same product. As discussed above the products may alternate between two specific products. For example, it may be used in food processing, battery manufacturing, jewelry packaging or any industry that requires handling of fragile goods.

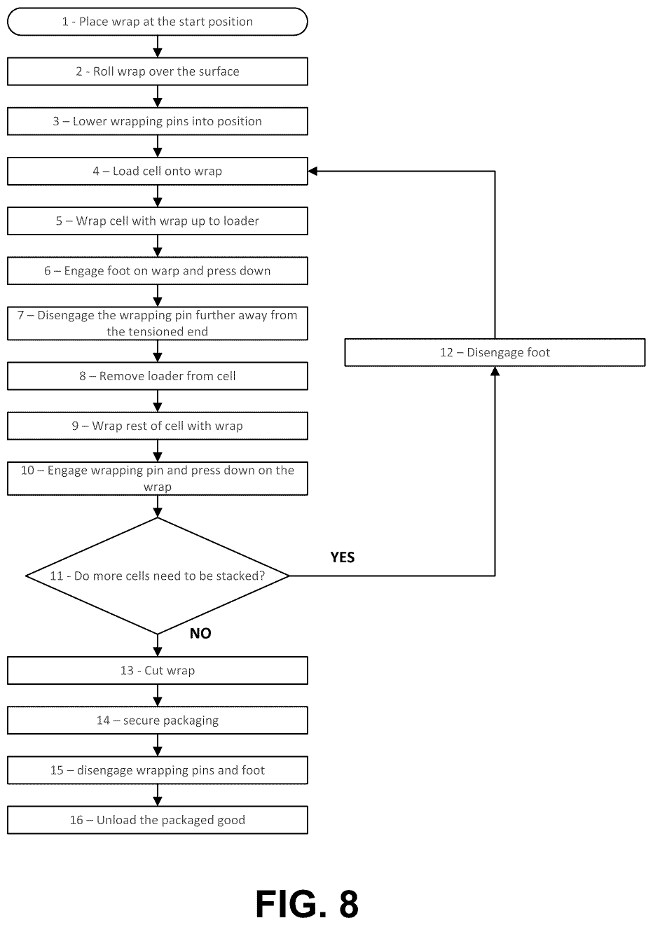

In use, the stacking and packing system 10 is used to make a stacked and wrapped product that consists of a plurality of products separated by wrap. Referring to FIG. 8, a flow chart shows the specific steps in the process. More broadly the process has three main phases, namely the initialization phase, the Z packaging phase, and the securing packaging and uploading phase.

The initialization phase is to prepare the packaging system to start packaging the product. This phase includes three steps that follow each other: step 1—installing the wrap at the start position, step 2—rolling the wrap over the packaging surface and step 3—lowering the wrapping pins in position on the wrap to immobilize the wrap.

The initialization phase of the process sets up all of the required setttings for the packaging step to happen, in the embodiment shown herein of stacking batteries components. The initial step is to setup the packaging wrap properly, which includes deploying it on the packaging surface.

The initialization phase may vary depending on the product being packaged. For example, if the system is processing food, the initialization process might require a cleaning stage to minimize cross contamination between batches.

The Z packaging phase is to stack vertically and package a varying number of products together. This phase includes 8 steps that follow each other: Step 4—Load the product onto the wrap, Step 5—Wrap the product with the wrap up to the loader, Step 6—engage the foot on the wrap and press down on the stack, Step 7—Disengage the wrapping pin further away from the tensioned end, Step 8—Remove the loader from the product, Step 9—wrap the rest of the product with the wrap, Step 10—engage the wrapping pin and press down on the wrap and step 11—do more products need to be stacked?.

If more products need to be stacked, then step 12 is required, which disengage the foot from the stack.

It will be appreciated by those skilled in the art that in the Z packaging phase certain steps may be done in alternate order and achieve the same result. For example, step 7 which disengages the wrapping pin could feasibly be applied either at its current place after step 6 or after step 8 or 9.

The Z packaging phase is a recursive process to package and stack a predefined plurality of products vertically, separated from a wrap that intertwines between the packaged product.

The Z packaging has very specific function, which is to package the product, however, the implementation of the phase may be adapted to the actual product. For example if the product are cells and are magnetic, the loaders could be electromagnets and the feet could be virtual and be replaced with electromagnets on the loading plate, pulling everything down instead of a physical foot pushing on it. Similarly, the loaders could use suction or sticking actions.

The securing packaging and unloading phase includes 4 steps: Step 13—cut the wrapping material, Step 14—Secure the packaging in place, Step 15—Disengage the wrapping pins and the foot from the stack and finally Step 16—Unload the packaged good to the unloading location.

The unloading section's purpose is to secure the packaging stack once it has been package and then unload it off the machine to prepare for the next goods to be packaged.

The required steps in the unloading section depends on the goods to be packaged and need to be designed in relation to it. For example, the securing the packaging could be done with clamps or a suction head.

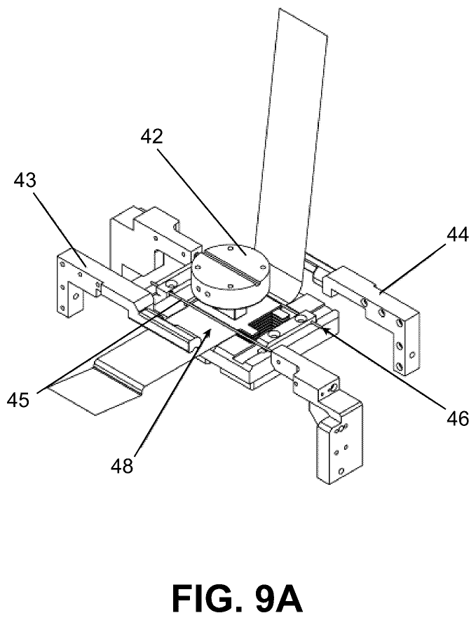

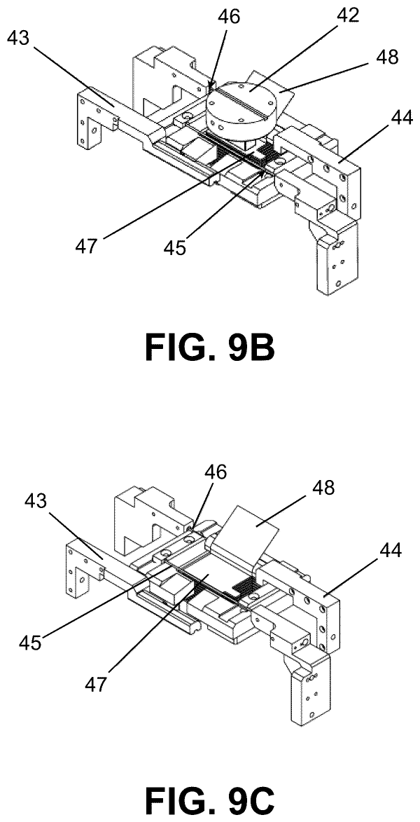

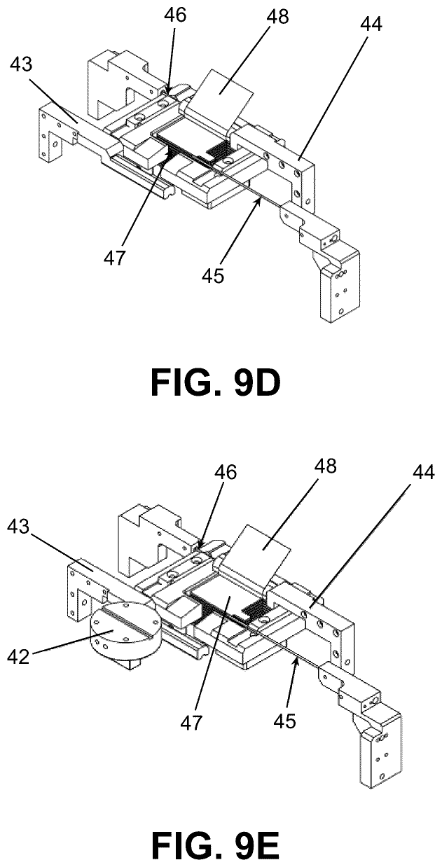

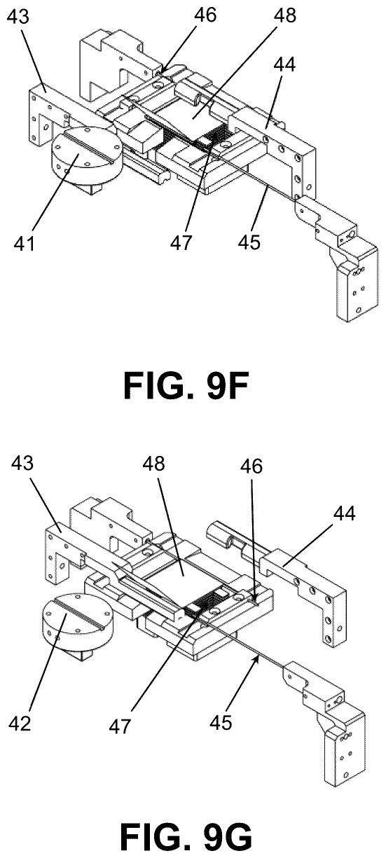

Referring to FIGS. 9A to 9G the steps in the process are shown with reference to specific elements of the stacking and packing system 10 shown herein. Specifically the process is shown with reference to the first wrapping pin 45 corresponding to the first foot 43; the second wrapping pin 46 and the corresponding second foot 44; the suction head 42; the wrap 48 and the product 47.

More specifically Step 4—Load the product onto the wrap is shown in FIG. 9A. Step 5
Wrap the product with the wrap up to the loader is shown in FIG. 9B. Step 6—engage the foot on the wrap and press down on the stack is shown in FIG. 9C. Step 7
Disengage the wrapping pin further away from the tensioned end is shown in FIG. 9D. Step 8—Remove the loader from the product is shown in FIG. 9E. Step 9—wrap the rest of the product with the wrap is shown in FIG. 9F. Step 10—engage the wrapping pin and press down on the wrap is shown in FIG. 9G.

The following examples are presented to enable those skilled in the art to understand and to practice embodiments of the present disclosure. They should not be considered as a limitation on the scope of the disclosure, but merely as being illustrative and representative thereof.

A stacking and packing system is for stacking and packing a plurality of products with a wrap. The stacking and packing system includes a Z stacking subsystem, a pick and place subsystem and a wrap management subsystem. The Z stacking subsystem has a stacking zone and is configured to stack the plurality of products and position the wrap between each of the plurality of products to form a plurality of stacked and wrapped product. The pick and place subsystem is configured to place one of the plurality of products onto the stacking zone. The wrap management subsystem is configured to move the wrap to the stacking zone.

The Z-stacking subsystem may include a first wrapping pin assembly having a first wrapping pin and a second wrapping pin assembly having a second wrapping pin wherein the second wrapping pin is spaced from the first wrapping pin. The first wrapping pin and the second wrapping pin may be configured to be positioned on opposing sides of one of the plurality of products when positioned in the stacking zone.

The first wrapping pin and the second wrapping pin may be spaced from one of the plurality of products when positioned in the stacking zone

The first wrapping pin and the second wrapping pin may be configured to move from an engaged position to a rest position wherein in the engaged position the first wrapping pin and the second wrapping pin may be on opposing sides of the stacking zone and in the rest position may be spaced from the stacking zone.

The first wrapping pin and the second wrapping pin may slide outwardly from the engaged position to the rest position generally horizontally.

The Z-stacking subsystem further includes a first foot assembly may have a first foot and a second foot assembly having a second foot wherein the second foot is spaced from the first foot.

The first foot and the second foot may each be configured to move from an engaged position to a rest position.

The engaged position for each of the first foot and the second foot may be in registration with the first wrapping pin and the second wrapping pin respectively.

The pick and place subsystem may include a suction head for picking up one of the plurality of products.

The wrap management subsystem may be configured to move the wrap backwardly and forwardly over the loading zone.

The wrap management subsystem may be further configured to tension the wrap as it moves backwardly and forwardly over the loading zone.

The stacking and packing system may further include a movement system for of the plurality of stack and wrapped product.

The plurality of products may be a plurality of thin cells.

The wrap may be a single continuous wrap.

The plurality of products may include alternating anodes and cathodes and the wrap is a packing material wherein the wrapped and stacked product forms a battery cell.

A Z stacking system for use with a product and a wrap includes a stacking zone for receiving the wrap and a product thereon; a first wrapping pin assembly having a first wrapping pin and a second wrapping pin assembly having a second wrapping pin wherein the second wrapping pin is spaced from the first wrapping pin on opposing sides of the stacking zone; and a first foot assembly having a first foot and a second foot assembly having a second foot wherein the second foot is spaced from the first foot on opposing side of the stacking zone.

The first wrapping pin and the second wrapping pin may be configured to be spaced from the products.

A method of stacking and packing a plurality of products having wrap therebetween using a first pin, a corresponding first foot, a second pin, and a corresponding second foot, the method comprises the steps of:
a) laying down the wrap;
b) moving the first pin and the second pin into an engagement position;
c) placing a product on the wrap between the first pin and the second pin with a loader;
d) wrapping the product with the wrap up to the loader and around the first pin;
e) moving the first corresponding foot into the engagement position over the first pin and pressing down;
f) moving the second pin into a rest position;
g) moving the loader
h) wrapping the remainder of the product;
i) moving the second pin into the engagement position on top of the wrap;
j) placing another product on the wrap between the first pin and the second pin with the loader;
k) wrapping the product with the wrap up to the loader and around the second pin;
l) moving the second corresponding foot into the engagement position over the second pin and pressing down;
m) moving the first pin into the rest position;
n) moving the loader;
o) repeating steps c) to l) until all of the plurality of products has been placed on the wrap; and
p) cutting the wrap.

The sequence of step f) and sequence of step m) may be variable.

The product in step c) may be a first product and the product in step j) may be a second product. The first product may be an anode and the second product may be a cathode. The wrapped and stacked plurality of products may be a battery.

The wrap may be tensioned.

The first wrapping pin and the wrapping second pin may be moved from the engaged position to the rest position generally horizontally.

The method of stacking and packing may further include the step of moving the wrapped and stacked plurality of products to a predetermined location.

The first wrapping pin and corresponding first foot may be in registration in the engagement position.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A stacking and packing system for stacking and packing a plurality of products and for use with a wrap comprising:
a Z-stacking subsystem having a stacking zone and being configured to stack the plurality of products and position the wrap between each of the plurality of products to form a plurality of stacked and wrapped product;
a pick and place subsystem configured to place one of the plurality of products onto the stacking zone; and
a wrap management subsystem configured to move the wrap to the stacking zone.

2. The stacking and packing system as claimed in claim 1 wherein the Z-stacking subsystem includes a first wrapping pin assembly having a first wrapping pin and a second wrapping pin assembly having a second wrapping pin wherein the second wrapping pin is spaced from the first wrapping pin.

3. The stacking and packing system as claimed in claim 2 wherein the first wrapping pin and the second wrapping pin configured to be positioned on opposing sides of one of the plurality of products when positioned in the stacking zone.

4. The stacking and packing system as claimed in claim 3 wherein the first wrapping pin and the second wrapping pin are spaced from one of the plurality of products when positioned in the stacking zone.

5. The stacking and packing system as claimed in claim 3 wherein the first wrapping pin and the second wrapping pin are configured to move from an engaged position to a rest position wherein in the engaged position the first wrapping pin and second wrapping pin are on opposing sides of the stacking zone and when in the rest position are spaced from stacking zone.

6. The stacking and packing system as claimed in claim 5 wherein the first wrapping pin and the second wrapping pin slide outwardly from the engaged position to the rest position generally horizontally.

7. The stacking and packing system as claimed in claim 2 wherein the Z-stacking subsystem further includes a first foot assembly having a first foot and a second foot assembly having a second foot wherein the second foot is spaced from the first foot.

8. The stacking and packing system as claimed in claim 7 wherein the first foot and the second foot are each configured to move from an engaged position to a rest position.

9. The stacking and packing system as claimed in claim 8 wherein in the engaged position each of the first foot and the second foot are in registration with the first wrapping pin and the second wrapping pin respectively.

10. The stacking and packing system as claimed in claim 1 wherein the pick and place subsystem includes a suction head for picking up one of the plurality of products.

11. The stacking and packing system as claimed in claim 1 wherein the wrap management subsystem is configured to move the wrap backwardly and forwardly over the stacking zone.

12. The stacking and packing system as claimed in claim 11 wherein the wrap management subsystem is further configured to tension the wrap as it moves backwardly and forwardly over the loading zone.

13. The stacking and packing system as claimed in claim 1 further including a movement system for of the plurality of stack and wrapped product.

14. The stacking and packing system as claimed in claim 1 wherein the plurality of products is a plurality of chips.

15. The stacking and packing system as claimed in claim 1 wherein the wrap is a single continuous packaging wrap.

16. The stacking and packing system as claimed in claim 1 wherein the plurality of products includes alternating anodes and cathodes and the wrap is a packing material wherein the wrapped and stacked product forms a battery cell.

17. A Z stacking system for use with a product and a wrap, comprising:
a stacking zone for receiving the wrap and the product thereon;
a first wrapping pin assembly having a first wrapping pin and a second wrapping pin assembly having a second wrapping pin wherein the second wrapping pin is spaced from the first wrapping pin on opposing sides of the stacking zone; and
a first foot assembly having a first foot and a second foot assembly having a second foot wherein the second foot is spaced from the first foot on opposing side of the stacking zone.

18. The Z stacking system as claimed in claim 17 wherein the first wrapping pin and the second wrapping pin are configured to move from an engaged position to a rest position and in the engaged position being spaced from the product positioned in the loading zone.

19. The Z stacking system as claimed in claim 18 wherein the first wrapping pin and the second wrapping pin slide outwardly from the engaged position to the rest position generally horizontally.

20. The Z stacking system as claimed in claim 17 wherein the first foot and the second foot are each configured to move from an engaged position to a rest position.

21. The Z stacking system as claimed in claim 20 wherein in the engaged position each of the first foot and the second foot are in registration with the first wrapping pin and the second wrapping pin respectively.

22. The Z stacking system as claimed in claim 17 wherein the first wrapping pin and the second wrapping pin are configured to be spaced from the products.

23. A method of stacking and packing a plurality of products having wrap therebetween using a first pin, a corresponding first foot, a second pin, and a corresponding second foot, the method comprising the steps of:
a) laying down the wrap;
b) moving the first wrapping pin and the second wrapping pin into an engagement position;
c) placing a product on the wrap between the first wrapping pin and the second wrapping pin with a loader;
d) wrapping the product with the wrap up to the loader and around the first wrapping pin;
e) moving the first corresponding foot into the engagement position over the first wrapping pin and pressing down;
f) moving the second wrapping pin into a rest position;
g) moving the loader;
h) wrapping the remainder of the product;
i) moving the second wrapping pin into the engagement position on top of the wrap;
j) placing another product on the wrap between the first wrapping pin and the second wrapping pin with the loader;
k) wrapping the product with the wrap up to the loader and around the second wrapping pin;
l) moving the second corresponding foot into the engagement position over the second wrapping pin and pressing down;
m) moving the first wrapping pin into the rest position;
n) moving the loader;
o) repeating steps c) to n) until all of the plurality of products has been placed on the wrap; and
p) cutting the wrap.

24. The method of stacking and packing as claimed in claim 23 wherein sequence of step f) and sequence of step m) are variable.

25. The method of stacking and packing as claimed in claim 23 wherein the product in step c) is a first product and the product in step j) is a second product.

26. The method of stacking and packing as claimed in claim 25 wherein the first product is an anode and the second product is a cathode.

27. The method of stacking and packing as claimed in claim 26 wherein the wrapped and stacked plurality of products is a battery.

28. The method of stacking and packing as claimed in claim 23 wherein the product is a thin cell.

29. The method of stacking and packing as claimed in claim 23 wherein the wrap is tensioned.

30. The method of stacking and packing as claimed in claim 23 wherein the first wrapping pin and the second wrapping pin are moved from the engaged position to the rest position generally horizontally.

31. The method of stacking and packing as claimed in claim 23 further including the step of moving the wrapped and stacked plurality of products to a predetermined location.

32. The method of stacking and packing as claimed in claim 23 wherein the first wrapping pin and the corresponding first foot are in registration in the engagement position.
